(19) United States
(12) Patent Application Publication
(10) Pub. No.: US 2025/0163534 A1
(43) Pub. Date: May 22, 2025

(54) HIGH PERFORMANCE THERMAL INSULATION OF A HEAT TREATMENT FURNACE FOR ANNEALING A CONTINUOUSLY MOVING STRIP

(71) Applicant: John Cockerill S.A., Seraing (BE)

(72) Inventor: Paul-Henri PICARD, Neupré (BE)

(21) Appl. No.: 18/839,446

(22) PCT Filed: Feb. 15, 2023
(86) PCT No.: PCT/EP2023/053691

§ 371 Date: Aug. 19, 2024

(30) Foreign Application Priority Data
Feb. 21, 2022 (EP) 22157736.4

(51) Int. Cl. C21D 9/56; C21D 9/62; F27D 1/00

(52) U.S. Cl. CPC C21D 9/562; C21D 9/561; C21D 9/62; F27D 1/0009; F27D 1/0036

(57) ABSTRACT

A furnace for performing a thermal treatment of a continuously moving metal strip includes: a hybrid wall lining facing inwardly of the furnace, the hybrid wall lining including a stack of polycrystalline fibre modules, and graphite lintels being fixed between or in the polycrystalline fibre modules; and electric heating elements provided inside the furnace along one or more vertical walls, and fixed on a side of the hybrid wall lining facing inwardly of the furnace. The polycrystalline fibre modules include fibres with at least 95% of Al2O3 so as to be compatible with a hydrogen protective atmosphere, a thickness of the polycrystalline fibre modules being between 200 and 500 mm. The electric heating elements are attached to the graphite lintels by a first anchoring system. The graphite lintels protect the electric heating elements against strip deviations by being cantilevered above the electric heating elements and protruding from the hybrid wall lining.

### CROSS-REFERENCE TO PRIOR APPLICATIONS

This application is a U.S. National Phase application under 35 U.S.C. § 371 of International Application No. PCT/EP2023/053691, filed on Feb. 15, 2023, and claims benefit to European Patent Application No. EP 22157736.4, filed on Feb. 21, 2022. The International Application was published in English on Aug. 24, 2023 as WO/2023/156418 under PCT Article 21(2).

### FIELD

The present invention relates to a specific insulation structure for lining furnaces such as a furnace in continuous bright annealing lines (BAL), which can be vertical or horizontal. More particularly, the insulation structure is intended to improve the thermal insulation performance of the annealing furnace and to ensure high quality of the steel.

The present invention is more generally applicable in technical field of continuous processing lines for strips of steel or aluminium, such as continuous annealing lines.

### BACKGROUND

It is known that bright annealing is an annealing process performed in a controlled atmosphere generally containing an inert gas and hydrogen. This controlled atmosphere reduces the surface oxidation to a minimum which results in a brighter surface mirror finish. As residual oxygen is entrained by the strip in the furnace, hydrogen should always be present in the furnace atmosphere, preferably with a content greater than 75%, the rest being inert gas such as nitrogen or argon. However in some annealing furnaces, hydrogen content can be lower than 75%.

In the vertical bright annealing furnace technology, the heating section of furnace is made in general of a stack of casing modules, comprising refractory bricks and an additional insulation. The traditional refractory bricks are often high purity bricks comprising 99% of alumina (Al₂O₃), made from bubble alumina, and typically with a bulk density of about 1800 kg/m³ and a porosity of 55%. The thermal conductivity of these traditional refractory bricks is typically 1.4 W/m° C. at 1200° C., for a maximum service temperature of 1850° C. The additional insulation can be made from kaowool (ceramic) bulk fibres of silica and alumina, the composition of bulk fibres being for example of 53% of SiO₂ and 47% of Al₂O₃. A classic thickness of bricks/additional fibre insulation is comprised between 200 and 250 mm.

Such a particular stack of casing modules is a proven technical solution comprising a lot of advantages, as the low maintenance and the facility to support scaffolding for this maintenance. Furthermore, it is easy to fix the heating elements thanks to embedded molybdenum anchors, and to provide protruding shield bricks to protect the heating elements. This is also a robust solution against strip breakage.

However, there are also some disadvantages, such as in particular a high thermal inertia which is the biggest issue, in particular with a high external casing temperature. Moreover, this solution is particularly heavy, with a large wall thickness (e.g. between 450 and 500 mm) and a long time needed for erecting the walls of the furnace. Further brick supports are needed, being a source of large heat loss and thermal bridge. Another problem is that cracks can occur in the bricks, leading to pieces of brick and dust falling in the vertical furnace, possibly damaging the strip. These pieces of bricks and dust can also cause fire at the outlet of the furnace, owing to possible contact of very hot pieces with air containing hydrogen at this location.

Solutions not involving ceramic bricks assemblies anymore are known. For example, Unifrax LLC (Tonawanda NY 14150, USA) has provided furnace lining (temperatures up to 1300° C.) under the form of polycrystalline fibre modules (Saffil® M-Fil Anchor-Loc® Modules), for example in forging applications.

Document US 2005/055940 A1 discloses a lining for a furnace, the lining having insulating material attached to an inside wall of the furnace, the insulating material in use having a hot face which faces inwardly of the furnace and a cold face at or adjacent the furnace wall, wherein a protective element is provided at least partially to cover the hot face, the protective element being secured relative to the hot face by a securing means which co-operates with a member which is embedded in the insulating material, and wherein the securing means is adapted to engage the member after the member is embedded in the insulating material. The furnace lining includes a plurality of individual blocks or modules of insulating material, each attached at the inside wall of the furnace, each module including a ceramic blanket which is folded to a block-like shape with the folds extending transversely to the furnace wall.

The protective element is made at least substantially of one or more of a ceramic material, a blanket of silica free insulation, a high-temperature resistant textile material, and a higher temperature resistant high alumina insulation than other insulation material of the lining.

Is also disclosed a fixing attached by one or more fasteners to the furnace wall made of a steel panel, the fixing having a hooked part which is embedded in the fibres of the module in a position where fixing rods (or tubes) are inserted through the folds to co-operate with the hooked part. The rods may co-operate with a plurality of fixings attaching modules to the inside of the furnace wall.

Utility model CN203336969U relates to an all-fiber energy-saving furnace lining outer cover. The all-fiber energy-saving furnace lining outer cover comprises a furnace body steel casing, polycrystalline mullite composite fiber bricks, an aluminum silicate zirconium fiberboard, supporting strip bricks, electric heating elements, polycrystalline mullite composite fiber lower surrounding bricks and polycrystalline mullite composite fiber upper surrounding bricks, wherein the polycrystalline mullite composite fiber bricks, the aluminum silicate zirconium fiberboard, the supporting strip bricks, the electric heating elements, the polycrystalline mullite composite fiber lower surrounding bricks and the polycrystalline mullite composite fiber upper surrounding bricks are arranged in the furnace body steel casing. The electric heating elements are arranged on the supporting strip bricks, the aluminum silicate zirconium fiberboard is arranged between the furnace body steel casing and the polycrystalline mullite composite fiber bricks, a zirconium fiber assembly is arranged at the top of a furnace lining, and the inner surface of the furnace lining is provided with an infrared radiation porous ceramic layer.

Document U.S. Pat. No. 4,486,888A discloses a furnace including a jacket which is removably mounted to a bottom plate construction so that the jacket can be mounted on anyone of a number of the bottom plate constructions. A cap is removably secured on an upper part of the jacket by latches, and electric resistance elements are mounted adjacent to an inner surface of the jacket by a plurality of strips having pins thereon. Since the jacket is removably mounted on the bottom plate construction, after a burning process has been completed, the jacket can be removed from the bottom plate construction and placed on another similar bottom plate construction to initiate another burning process while the products which have been previously burned are allowed to cool. In the event that quick cooling of the products is not desirable, the cap may be removed and replaced by a simple, intermediate cap so that the products are allowed to cool more slowly.

### SUMMARY

In an embodiment, the present invention provides a furnace for performing a thermal treatment of a continuously moving metal strip, comprising: a hybrid wall lining facing inwardly of the furnace, the hybrid wall lining comprising a stack of polycrystalline fibre modules, and graphite lintels being fixed between or in the polycrystalline fibre modules; and electric heating elements provided inside the furnace along one or more vertical walls, and fixed on a side of the hybrid wall lining facing inwardly of the furnace, wherein the polycrystalline fibre modules comprise fibres with at least 95% of Al₂O₃ so as to be compatible with a hydrogen protective atmosphere, a thickness of the polycrystalline fibre modules being between 200 and 500 mm, wherein the electric heating elements are attached to the graphite lintels by a first anchoring system, and wherein the graphite lintels are configured to protect the electric heating elements against strip deviations by being cantilevered above the electric heating elements and protruding from the hybrid wall lining.

### BRIEF DESCRIPTION OF THE DRAWINGS

The present invention will be described in even greater detail below based on the exemplary figures. The invention is not limited to the exemplary embodiments. Other features and advantages of various embodiments of the present invention will become apparent by reading the following detailed description with reference to the attached drawings which illustrate the following:

FIG. 1 represents a cross-sectional longitudinal view of a vertical bright annealing furnace of prior art.

FIG. 2 represents a cross-sectional lateral view of a vertical bright annealing furnace of prior art.

FIG. 3 represents a 3D view of a part of a furnace with a lining comprising polycrystalline fibre modules according to the present invention.

FIG. 4 represents a first cross-sectional view of the furnace of FIG. 3.

FIG. 5 represents a second cross-sectional view of the furnace of FIG. 3.

FIG. 6 represents a third cross-sectional view of the furnace of FIG. 3.

FIG. 7 represents a detailed cross-sectional view of an anchoring system of a heating element in a common vertical bright annealing furnace of prior art.

FIG. 8 represents a detailed cross-sectional view of an anchoring system of a heating element in a module of a vertical bright annealing furnace according to the present invention.

FIG. 9 shows the temperature distribution in the thickness of a wall of a vertical bright annealing furnace of prior art.

FIG. 10 shows the temperature distribution in the thickness of a wall of a bright annealing furnace with a lining comprising polycrystalline fibre modules according to the present invention.

FIG. 11 represents a detailed view of a system for anchoring the polycrystalline fibre modules to the furnace casing according to prior art.

FIG. 12 represents a detailed cross-sectional view of an anchoring system of a heating element in a module of a vertical bright annealing furnace according to the present invention, in which the polycrystalline fibre modules have been replaced by graphite rigid felt boards.

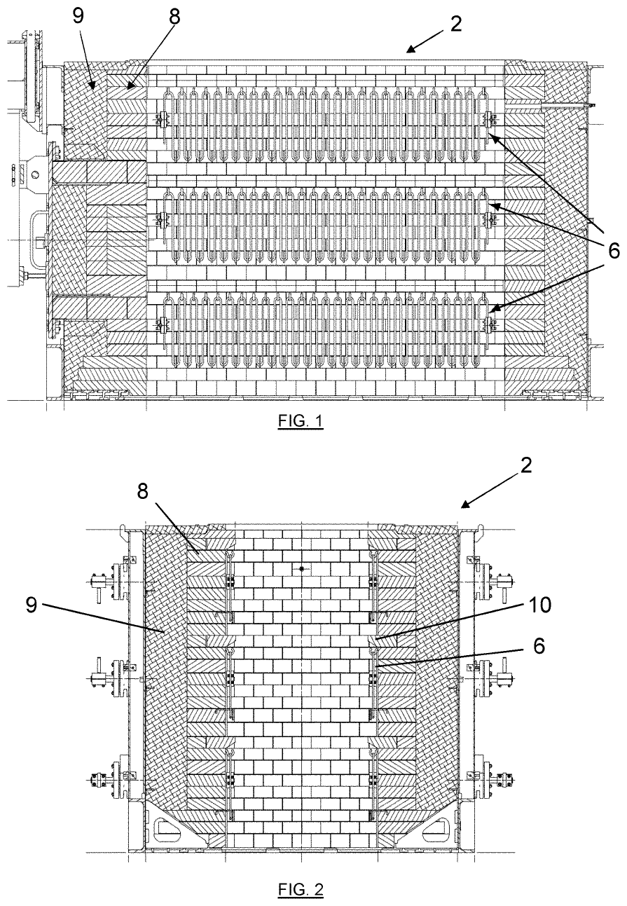

### DETAILED DESCRIPTION

In an embodiment, the present invention provides an insulated wall structure for e.g. a vertical bright annealing furnace which does not present the drawbacks of the above-mentioned prior art structures, and which optimizes both thermal insulation performances and thermal inertia, while ensuring high quality of the thermally-treated steel strip.

The aimed low thermal inertia of the structure of the present invention should provide a more flexible furnace temperature with a shorter response time, allowing to recover expected operating conditions more quickly and the possibility to quickly switch off the furnace if necessary.

The invention also aims to provide an innovative solution, having elements which are light and fast to erect. The structure of the present invention should allow to avoid the risk of cracks related to the use of insulating bricks, and of pieces of bricks and dust falling in the vertical furnace and thus minimize possible damage on the strip when it is travelling.

Further the present invention aims at replacing the insulating bricks in their role of mechanical support of the heating elements, also considering that the new support should not react with the hydrogen atmosphere in the furnace.

Finally the invention should render not necessary to have brick support at the base of the furnace, avoiding thermal bridges.

A first aspect of the present invention relates to a furnace for performing a thermal treatment of a continuously moving metal strip, preferably under hydrogen protective atmosphere, having:
a hybrid wall lining facing inwardly of the furnace, wherein said hybrid wall lining comprises a stack of polycrystalline fibre modules, and graphite lintels being fixed between or in said modules, and
electric heating elements provided inside the furnace along one or more vertical walls and fixed on the side of the hybrid wall lining facing inwardly of the furnace,
wherein said polycrystalline fibre modules comprise fibres with at least 95% of Al₂O₃, and preferably at least 97% of Al₂O₃, so as to be compatible with a hydrogen protective atmosphere, the thickness of the polycrystalline fibre modules being comprised between 200 and 500 mm,
wherein the electric heating elements are attached to the graphite lintels thanks to a first anchoring system, and
wherein the graphite lintels are suitable to protect the heating elements against strip deviations, by being cantilevered above the heating elements and protruding from the wall lining inside the furnace.

According to preferred embodiments of the invention, the furnace is further limited by one of the following features or by a suitable combination thereof
each of the polycrystalline fibre modules is provided with a second anchoring system suitable to fix said module to at least one adjacent module and/or to the external casing of the furnace;
said wall lining comprises additional bulk fibre or fibre blanket or board between the stack of polycrystalline modules and the external casing of the furnace;
the additional bulk fibre or fibre blanket or board has a thickness between 20 and 250 mm;
supporting tubes are, at one end, attached inside the graphite lintels and, at the other end, welded, perpendicularly, to the casing of the furnace in order to support the graphite lintels;
a space is provided between the interior end of each graphite lintel and the casing of the furnace, said space comprising the tube supporting the lintel and being filled with bulk fibres;
the heating elements are forming a continuous planar serpentine and the graphite lintels are arranged in horizontal rows and are provided with the first anchoring system made of vertical hooks, so that adjacent vertical hooks located in two vertically adjacent lintel rows are respectively supporting the lower and upper successive loops of the heating element;
the furnace is a furnace in a continuous annealing line;
the furnace is a vertical furnace;
the furnace is a horizontal furnace.

A second aspect of the present invention relates to the use of the furnace described above, for performing a thermal treatment of a continuously moving metal strip, preferably under a controlled hydrogen protective atmosphere.

Preferably, the controlled hydrogen protective atmosphere has a hydrogen content greater than 75%, the rest being inert gas.

Advantageously, the thermal treatment of a continuously moving metal strip is a treatment for strips of steel or aluminium, preferably in continuous annealing lines.

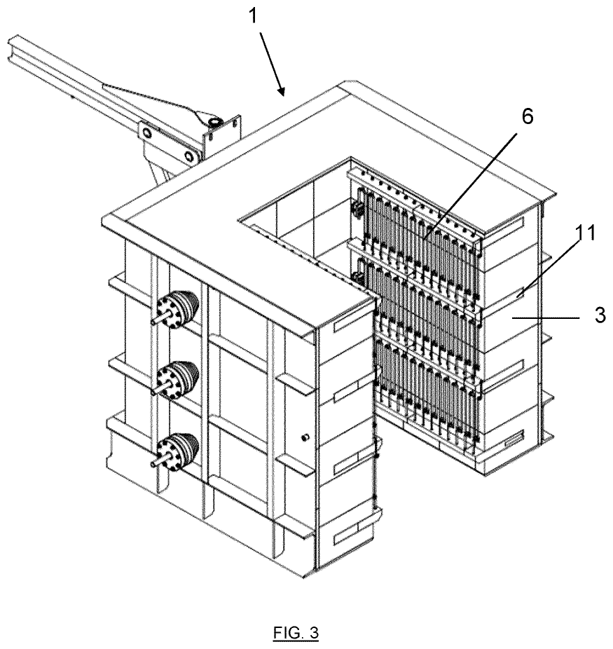

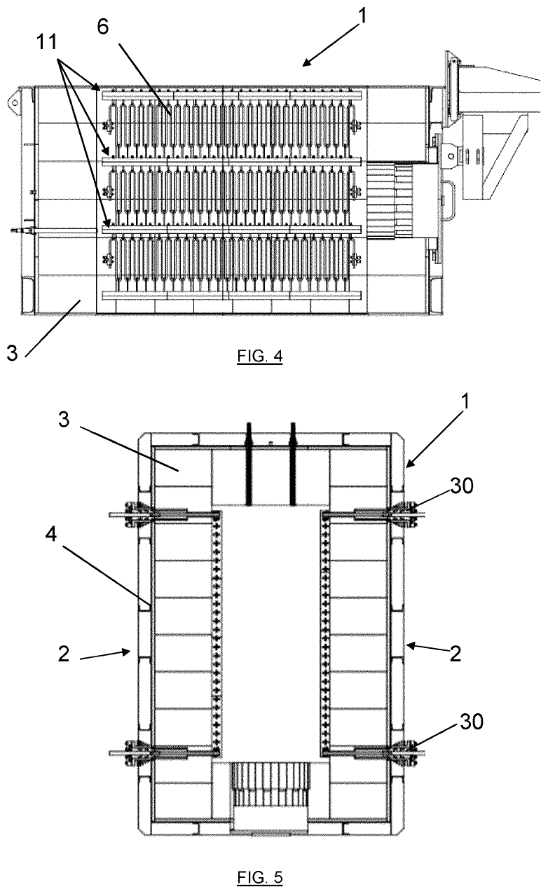

The present invention relates to a new wall structure 2 for a vertical bright annealing furnace 1. This specific structure comprises a stack of insulating polycrystalline fibre modules 3 as illustrated by FIGS. 3 to 6. Once the modules 3 are assembled and fixed to form the wall 2, an additional fibre blanket 4 can be added in the furnace 1 between the polycrystalline fibre modules 3 and the casing.

Each module 3 has preferably a thickness between 400 and 500 mm, and more preferably of 450 mm. The additional fibre blanket 4 has preferably a thickness between 20 and 50 mm, and more preferably of 25 mm.

The insulating polycrystalline fibre modules 3 preferably comprise fibre with at least 95-97% of Al₂O₃.

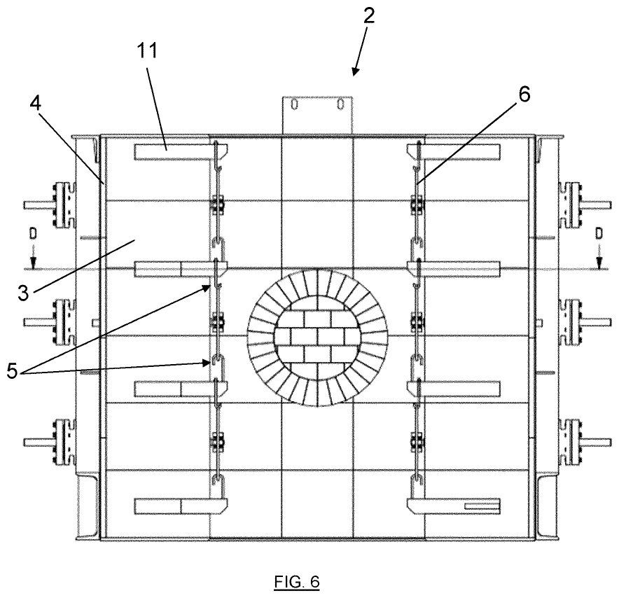

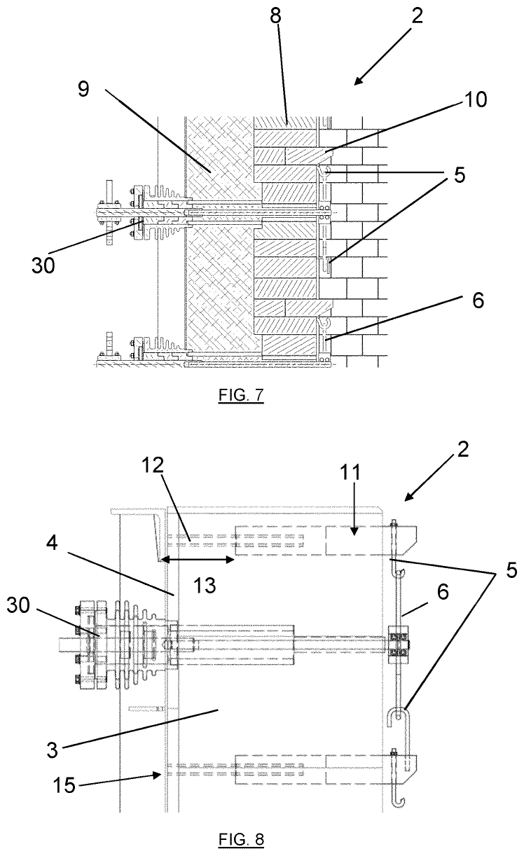

As explained below, and illustrated by FIGS. 3-4, 6 and 8, electric heating elements 6 are provided inside the furnace 1. The heating elements 6 are fixed to the modules 3 by an anchoring system 5. In order to protect the heating elements 6 against shocks due to the contact with the running or broken strip in the furnace 2, graphite lintels 11 are provided, preferably provided with chicanes. Graphite lintels 11 are fixed in the wall 2 between and/or within modules 3, and are cantilevered just above each heating element 6 (see FIGS. 6 and 8). This is more detailed in the following sections of the description.

The wall 2 obtained with the modules 3 of the present invention exhibits an improved thermal insulation and thermal inertia offering a more flexible furnace temperature. This new solution will give the opportunity to have a wall lighter and easier to build, with no risk of cracks or fire in operation.

### Polycrystalline Fibre Modules

Polycrystalline fibre modules 3 of the present invention can be for example a polycrystalline Saffil® M-Fil prefabricated modules (source: Unifrax documentation). Saffil® M-Fil modules 3 are manufactured from polycrystalline wool into a standard edge-stacked construction format. The modules are made of fibre compressed with cardboard (ou wooden) side plates with banding straps. These prefabricated modules 3 are specifically designed to meet the thermal insulation requirements of industrial furnaces. As illustrated in FIG. 11, Saffil modules can be produced with various anchoring systems 14, 16, known per se of the skilled person and often commercially available, to enable quick, easy and efficient installation for most lining applications.

### Graphite Rigid Felt Boards

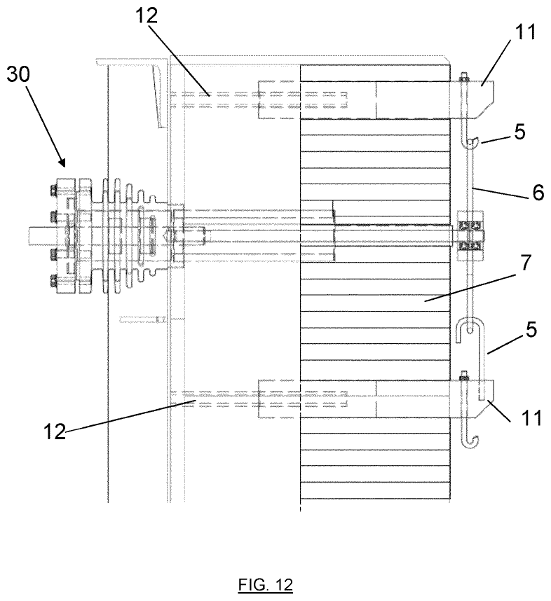

In an alternative embodiment shown on FIG. 12, polycrystalline alumina fibre modules can be replaced by a stack of graphite rigid felt boards 7, preferably horizontally arranged. This material has a carbon content of 99.5% and is very light (bulk density of about 0.2 g/cm³).

### Polycrystalline Fibre Modules and Heating Elements: Assembly and Anchoring Method

Polycrystalline fibre modules 3 according to the present invention can be assembled and fixed according different fixing methods known from prior art (see for example Unifrax documentation).

A first system, named “RX2 anchoring system” is a patented metal support in 321 stainless steel, which provides rapid attachment of the module 3 to the furnace casing via the external side fastener which is screwed onto a pre-welded stud. Rail, washer, nut, stud and ceramic arc shield are supplied (see US 2005/055940 A1, ref. 14, 15, 18).

A second system, named “Thread Lock (TL) anchoring system” 14 and illustrated in FIG. 11, is attached to the furnace casing 15 by a central anchor in 304 stainless steel. Threaded studs 16 are pre-welded on the internal side of the furnace casing and the module anchor 14 is screwed on the stud by using a tool 20 such as a ratchet drive. The module anchor 14 has two wings terminated each with a hole 17 for supporting an assembly tube or rod linked in the same manner to adjacent module anchors.

The “TL anchoring system” has been especially designed for three reasons:
as a complementary assembly system to RX2 or similar;
for the lining of small furnaces;
to repair all types of lining installations.

Other similar systems are available off the shelf.

### Heating Element Protection

In the bright annealing vertical furnace technology of prior art, as illustrated in FIG. 7, shield bricks 10 containing 99% Al₂O₃ are provided to protect the heating elements 6. These shield bricks are easy to implement, because they are refractory bricks 8 being placed so that they protrude inside the furnace 1, just above the vertical heating elements 6. In this manner, the travelling strip is prevented to hit the heating elements 6 being below the shield bricks 10.

In the case of the present invention, the fibre modules 3 per se do not allow to protect the heating elements 6 while forming the walls 2 of the furnace 1. Another shielding solution is therefore needed.

As illustrated in FIGS. 6 and 8, according to the present invention, graphite lintels 11 have been provided between fibre modules 3, just above the heating elements 6.

Graphite lintels 11 can be advantageously obtained from machinable extruded graphite. Graphite is dense, has high temperature resistance and does not react with hydrogen. See example of data sheet below (mechanical data: “with the grain”):

| | | |
|---|---|---|
| Bulk density | g/cm³ | 1.7 |
| Open porosity | % | 17 |
| Young modulus | GPa | 10 |
| Flexural strength | MPa | 18 |
| Compressive strength | MPa | 39 |
| Tensile strength | Mpa | 13 |

In a vertical furnace or in a horizontal furnace with heating elements arranged along vertical walls, the graphite lintels 11 advantageously protrude from a vertical wall line inside the furnace 1 to protect the heating elements 6. Additionally, the graphite lintels 11 have also the function of supporting and guiding the heating elements 6, via an anchoring system 5, for example under the form of molybdenum hooks.

The heating elements 6 are preferably electric heating elements arranged according to a planar serpentine connected at each of its two ends to an insulated connector 30 going through the wall lining 2 and the external casing 15 of the furnace 1 to the power supply.

The graphite lintels 11 are arranged in horizontal rows and are provided with anchoring system 5 made of vertical hooks, preferably made of molybdenum, so that adjacent vertical hooks located in two vertically adjacent lintel rows are respectively supporting the lower and upper successive loops of the heating element.

Still according to the invention (see FIG. 8), supporting tubes 12 are welded to the casing 15 of the furnace in order to support the graphite lintels 11 in the insulation assembly. Further, a space 13 is provided between the back of the lintel 11 and the casing 15 of the furnace. This space 13 encloses the tube 12 supporting the lintel 11, and can be filled with bulk fibres known per se of the skilled person. In case the wall lining 2 comprises boards of graphite rigid felt, said boards are supported by the horizontal layers of graphite lintels 11 and attached to the casing with usual anchoring means (such as for bricks).

Such as polycrystalline alumina fibre modules, graphite lintels 11 do not have the defects of the shield bricks 10 of prior art, such as cracks or breaks prone to occur in the bricks, possibly leading to pieces of brick and dust falling in the vertical furnace, and possibly damaging the strip or causing fire at the outlet of the furnace.

In a horizontal furnace, two configurations can be adopted:
in a first configuration, the heating elements are located in the vertical walls of the furnace. To take over the protection role of the insulation bricks against the deviation of the strip, the insulation fibre structure should be provided with a protective frame with at least two vertical lintels and two horizontal lintels, as described above, for each heating unit;
in a second configuration, the heating elements are provided in the dome of the furnace. In this case, there is no (or less) need for protecting the heating elements.

### Performances

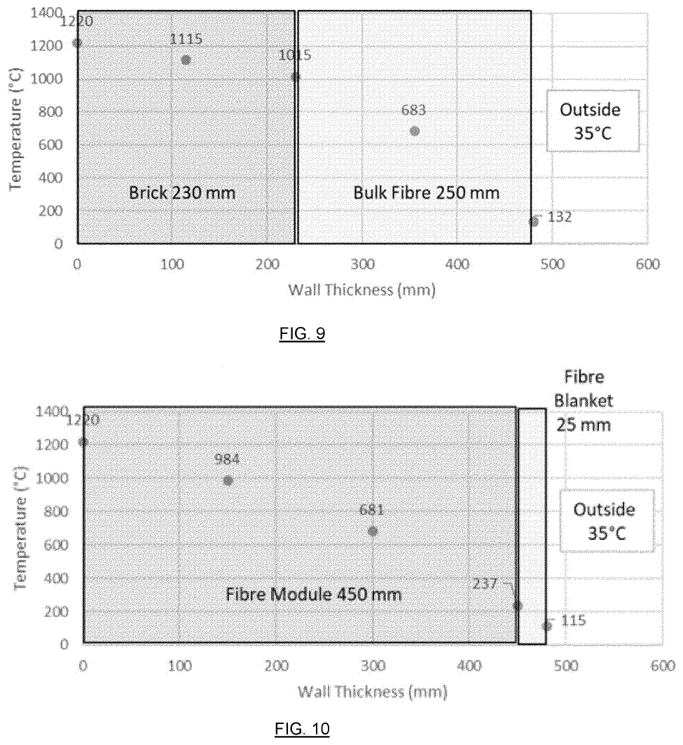

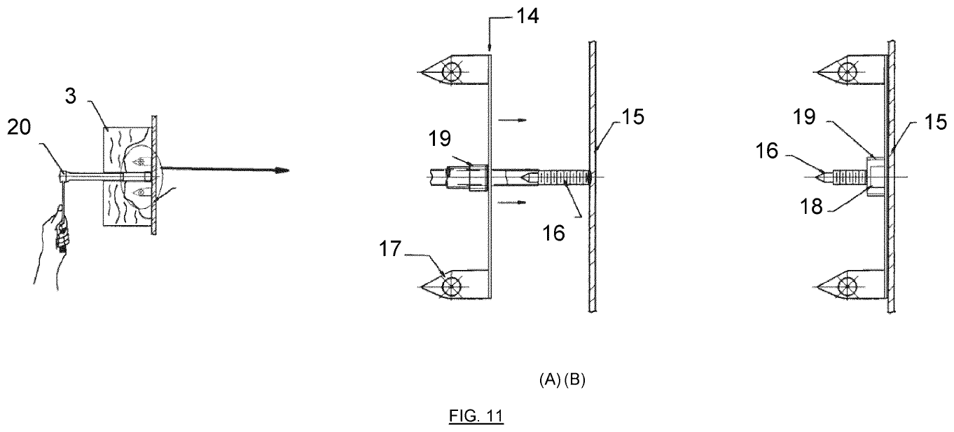

The performances of the polycrystalline fibre modules 3 of the present invention are compared to the stack of casing modules of prior art, comprising refractory bricks and additional insulation. The results are illustrated in FIG. 9 representing the temperature distribution in the thickness of a wall of the vertical bright annealing furnace of prior art, and in FIG. 10 representing the temperature distribution in the thickness of a wall of the bright annealing furnace with the structure of the present

The calculation hypotheses are the same for both cases.

In the example, the wall of the bright annealing furnace of prior art comprises stack of casing modules with refractory bricks 8 and additional insulation 9 (made of bulk fibres). The wall of a bright annealing furnace according to the present invention comprises a structure with polycrystalline fibre modules 3 having a thickness of 450 mm and an additional fibre blanket (backup layer faced with aluminium foil, e.g. Insulfrax® S blanket, documentation Unifrax) having a thickness of 25 mm.

As illustrated by FIG. 9, in case of the furnace of prior art, the external casing temperature of the furnace is 132° C., leading to a thermal flux of 1460 W/m2.

As illustrated by FIG. 10, in case of the furnace of the present invention, the external casing temperature of the furnace is 115° C., leading to a thermal flux of 1122 W/m2.

The lining of the furnace walls in the present invention allows a reduction of external casing temperature of 17° C. and of thermal flux of 23%.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below. Additionally, statements made herein characterizing the invention refer to an embodiment of the invention and not necessarily all embodiments.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

### REFERENCE SYMBOLS

1 Vertical bright annealing furnace
2 Wall of the furnace (with lining)
3 Polycrystalline fibre modules
4 Additional fibre blanket
Anchoring system of a heating element
6 Heating element
7 Graphite rigid felt board
8 Refractory brick
9 Additional insulation
Shield brick
11 Graphite lintel
12 Supporting tube
13 Space between the lintel and the furnace casing
14 “Thread Lock” anchoring system of the module
Furnace casing
16 Threaded stud
17 Tube supporting wing
18 Flange hex nut
19 Sliding collar
20 Tool
30 Insulated connector

1: A furnace for performing a thermal treatment of a continuously moving metal strip, comprising:
a hybrid wall lining facing inwardly of the furnace, the hybrid wall lining comprising a stack of polycrystalline fibre modules, and graphite lintels being fixed between or in the polycrystalline fibre modules; and
electric heating elements provided inside the furnace along one or more vertical walls, and fixed on a side of the hybrid wall lining facing inwardly of the furnace,
wherein the polycrystalline fibre modules comprise fibres with at least 95% of Al2O3 so as to be compatible with a hydrogen protective atmosphere, a thickness of the polycrystalline fibre modules being between 200 and 500 mm,
wherein the electric heating elements are attached to the graphite lintels by a first anchoring system,
and
wherein the graphite lintels are configured to protect the electric heating elements against strip deviations by being cantilevered above the electric heating elements and protruding from the hybrid wall lining.

2: The furnace of claim 1, wherein each polycrystalline fibre module of the polycrystalline fibre modules is provided with a second anchoring system configured to fix a respective polycrystalline fibre module to at least one adjacent polycrystalline fibre module and/or to an external casing of the furnace.

3: The furnace of claim 1, wherein the wall lining comprises additional bulk fibre or fibre blanket or board between the stack of polycrystalline fibre modules and an external casing of the furnace.

4: The furnace of claim 3, wherein the additional bulk fibre or fibre blanket or board has a thickness between 20 and 250 mm.

5. (canceled)

6: The furnace of claim 1, wherein supporting tubes are, at one end, attached inside the graphite lintels and, at an other end, welded, perpendicularly, to an external casing of the furnace to support the graphite lintels.

7: The furnace of claim 6, wherein a space is provided between an interior end of each graphite lintel of the graphite lintels and the external casing of the furnace, the space including a respective supporting tube supporting a respective graphite lintel and being filled with bulk fibres.

8: The furnace of claim 1, wherein the electric heating elements form a continuous planar serpentine, and
wherein the graphite lintels are arranged in horizontal rows and are provided with the first anchoring system, which comprises vertical hooks, so that adjacent vertical hooks located in two vertically adjacent lintel rows respectively support lower and upper successive loops of the electric heating elements.

9: The furnace of claim 1, wherein the furnace is a furnace in a continuous annealing line.

10: The furnace of claim 1, wherein the furnace is a vertical furnace.

11: The furnace of anyone of claim 1, wherein the furnace is a horizontal furnace.

12. (canceled)

13: A method, comprising:
providing the furnace claim 1; and
performing the thermal treatment of the continuously moving metal strip using the furnace.

14: The method of claim 18, wherein the controlled hydrogen protective atmosphere has a hydrogen content greater than 75%, a remainder of the controlled hydrogen protective atmosphere being inert gas.

15: The method of claim 13, wherein the thermal treatment of the continuously moving metal strip comprises a treatment for strips of steel or aluminium.

16: The furnace of claim 1, wherein the thermal treatment is performed under hydrogen protective atmosphere.

17: The furnace of claim 1, wherein the polycrystalline fibre modules comprise fibres with at least 97% of Al2O3.

18: The method of claim 13, wherein the thermal treatment is performed under a controlled hydrogen protective atmosphere.

19: The method of claim 15, wherein the treatment for strips of steel or aluminium comprises treatment for strips of steel or aluminium in continuous annealing lines.
